(19) United States
(12) Patent Application Publication
(10) Pub. No.: US 2012/0287946 A1
(43) Pub. Date: Nov. 15, 2012

(54) Hash-Based Load Balancing with Flow Identifier Remapping

(75) Inventors: Brad MATTHEWS, San Jose, CA (US); Puneet Agarwal, Cupertino, CA (US)

(73) Assignee: Broadcom Corporation, Irvine, CA (US)

(21) Appl. No.: 13/404,785

(22) Filed: Feb. 24, 2012

Related U.S. Application Data
(60) Provisional application No. 61/486,057, filed on May 13, 2011.

(51) Int. Cl. H04J 3/24

(52) U.S. Cl. 370/474

(57) ABSTRACT

Methods and apparatus for improving hash-based load balancing using flow identifier remapping are disclosed. The node-based remapping of flow identifiers introduces additional information into the hash function by injecting new values into the hash key on a per node basis. The methods and apparatus described herein perform a remapping operation on a fixed per-flow attribute such as one or more packet fields. Upon receipt of a packet, a set of the packet fields is selected as a hash key. From these selected packet fields, one or more fields are selected and remapped using a remapping operation. A transformed hash key is formed using the one or more remapped values along with other packet fields. The transformed hash key is then presented as an input to an arbitrary hash function. The hash function generates a hash value that is then used for path selection.

### CROSS REFERENCE TO RELATED CASES

This application claims the benefit of U.S. Provisional Patent Application No. 61/486,057, filed May 13, 2011 which is incorporated by herein by reference in its entirety.

### FIELD OF THE INVENTION

This application relates generally to improving hash function performance and specifically to improving load balancing in data networks.

### BACKGROUND

In large networks having multiple interconnected devices, traffic between source and destination devices typically traverses multiple hops. In these networks, devices that process and communicate data traffic often implement multiple equal cost paths across which data traffic may be communicated between a source device and a destination device. In certain applications, multiple communications links between two devices in a network may be grouped together (e.g., as a logical trunk or an aggregation group). The data communication links of an aggregation group (referred to as “members”) may be physical links or alternatively virtual (or logical) links.

Aggregation groups may be implemented in a number of fashions. For example, an aggregation group may be implemented using Layer-3 (L3) Equal Cost Multi-Path (ECMP) techniques. Alternatively, an aggregation group may be implemented as a link aggregation group (LAG) in accordance with the IEEE 802.3ad standard. In another embodiment, an aggregation group may be implemented as a Hi-Gig trunk. As would be appreciated by persons of skill in the art, other techniques for implementing an aggregation group may be used.

In applications using multiple paths between devices, traffic distribution across members of the aggregate group must be as even as possible to maximize throughput. Network devices (nodes) may use load balancing techniques to achieve distribution of data traffic across the links of an aggregation group. A key requirement of load balancing for aggregates is that packet order must be preserved for all packets in a flow. Additionally, the techniques used must be deterministic so that packet flow through the network can be traced.

Hash-based load balancing is a common approach used in modem packet switches to distribute flows to members of an aggregate group. To perform such hash-based load balancing across a set of aggregates, a common approach is to hash a set of packet fields to resolve which among a set of possible route choices to select (e.g., which member of an aggregate). At every hop in the network, each node may have more than one possible next-hop/link that will lead to the same destination.

In a network or network device, each node would select a next-hop/link based on a hash of a set of packet fields which do not change for the duration of a flow. A flow may be defined by a number of different parameters, such as source and destination addresses (e.g., IP addresses or MAC addresses), TCP flow parameters, or any set of parameters that are common to a given set of data traffic. Using such an approach, packets within a flow, or set of flows that produce the same hash value, will follow the same path at every hop. Since binding of flows to the next hop/link is fixed, all packets will traverse a path in order and packet sequence is guaranteed. However, this approach leads to poor distribution of multiple flows to aggregate members and causes starvation of nodes, particularly in large multi-hop, multi-path networks (e.g., certain nodes in a multi-hop network may not receive any data traffic), especially as one moves further away from the node (called root node) at which the traffic entered the network.

What is therefore needed are techniques for providing randomization and improved distribution to aggregate members.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates a block diagram of a single-hop of a multi-hop network in accordance with an embodiment of the invention.

FIG. 2 illustrates a block diagram of two hops of a multi-path network in accordance with an embodiment of the invention.

FIG. 3 is a block diagram illustrating a network node, in accordance with an embodiment of the present invention.

FIG. 4 is a flowchart illustrating a method for hash-based load balancing with flow identifier remapping, according to an embodiment of the present invention.

FIG. 5 depicts high level block diagram of a system for initialization of the flow identifier remapping table, according to embodiments of the invention.

FIG. 6 is a flowchart illustrating a method for initialization of the flow mapping table, according to an embodiment of the present invention.

FIG. 7 illustrates the extraction and selection of packet fields for remapping, according to embodiments of the present invention.

FIG. 8A illustrates an exemplary one-to-one remapping for a single field, according to embodiments of the present invention.

FIG. 8B illustrates an exemplary one-to-one remapping for multiple fields, according to embodiments of the present invention.

FIG. 9 illustrates an example of the use of a remapping function, according to embodiments of the present invention.

FIG. 10 illustrates an exemplary group remapping, according to embodiments of the present invention.

FIG. 11 illustrates an example computer system in which embodiments of the present invention, or portions thereof, can be implemented as computer-readable code.

The present invention will be described with reference to the accompanying drawings. The drawing in which an element first appears is typically indicated by the leftmost digit(s) in the corresponding reference number.

### DETAILED DESCRIPTION

In the following description, numerous specific details are set forth in order to provide a thorough understanding of the invention. However, it will be apparent to those skilled in the art that the invention, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the invention.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

FIG. 1 is block diagram illustrating a single-hop of a multi-path network 100 (network 100), according to embodiments of the present invention. For purposes of this disclosure, a node may be viewed as any level of granularity in a data network. For example, a node could be an incoming data port, a combination of the incoming data port and an aggregation group, a network device, a packet switch, or may be some other level of granularity. The network 100 includes three nodes, Node 0 105, Node 1 110 and Node 2 115. In the network 100, data traffic (e.g., data packets) may enter the network 100 via Node 0 105 (referred to as the “root” node). Depending on the data traffic, Node 0 105, after receiving the data traffic, may then select a next-hop/link for the data traffic. In this example, the Node 0 105 may decide to send certain data packets to the Node 1 110 and send other data packets to the Node 2 115. These data packets may include data information, voice information, video information or any other type of information.

In a multi-path network, the Node 1 110 and the Node 2 115 may be connected to other nodes in such a fashion that data traffic sent to either node can arrive at the same destination. In such approaches, the process of binding a flow to a next-hop/link may begin by extracting a subset of static fields in a packet header (e.g., Source IP, Destination IP, etc.) to form a hash key. A hash key may map to multiple flows. However, all packets in a flow will have the same hash key. If the hash key were to change for packets within a flow, a fixed binding of a flow to a next-hop/link would not be guaranteed and re-ordering of packets in that flow may occur at one or more nodes. Packet re-ordering could lead to degraded performance for some communication protocols (e.g., TCP).

The hash key then serves as an input to a hash function, commonly a CRC16 variant or CRC32 variant, which produces, respectively, a 16-bit or 32-bit hash value. In some implementations, a CRCXX hash function is used. As would be appreciated by a person of ordinary skill in the art, other switches may use different hash functions (E.g., Pearson's hash). Typically, only a subset of the hash value bits is used by a given application (e.g., Trunking, LAGs, and ECMP), herein, collectively, aggregation group(s)). Unused bits of the hash value are masked out and only the masked hash value is used to bind a flow to one of the N aggregate members, where N is the number of links that belong to a given aggregation group.

The list of N aggregate members may be maintained in a destination mapping table for a given aggregate. Each table entry contains forwarding information indicating a link (next hop). The index into the destination mapping table may be calculated as the remainder of the masked hash value modulo N (the number of aggregate group members), such as the one shown below by Equation 1.

destination table index=masked_hash_value_mod N (1)

Using the destination table index, the node may determine the next-hop/link destination (aggregate member) for each packet. This process binds a flow or set of flows to a single aggregate member using a mathematical transformation that will always select the same aggregate member for a given hash key at each node.

As discussed above, network 100 is a single-hop network (depth=1 with two layers) that may be part of a larger multi-hop, multi-path network that performs forwarding for flows going to the same or different destinations. As previously indicated, all data traffic that is communicated in the network 100 traffic may enter the network 100 via a root node. For purposes of this example, it will be assumed that all flows can reach any destination of a larger network of which the network 100 is a part of using any leaf of an N-ary tree rooted at the Node 0 105. In such a network, packets originating at the root node will pick between 1 to N aggregate members from which the packet should depart using a hashing function. If each flow has a unique hash key and the hash function distributes hash-values equally over the hash values 16-bit space, then flows arriving to the Node 0 105 will be distributed evenly to each of its two child nodes, Node 1 110 and Node 2 115.

If the depth of the tree is one (as shown in FIG. 1), flows are evenly distributed and there are no starved paths (paths that receive no traffic). Therefore, in this example, neither Node 1 110 or Node 2 115 will receive a disproportionate number of flows and, accordingly, there are no starved leaf nodes (i.e. leaf nodes that receive no traffic).

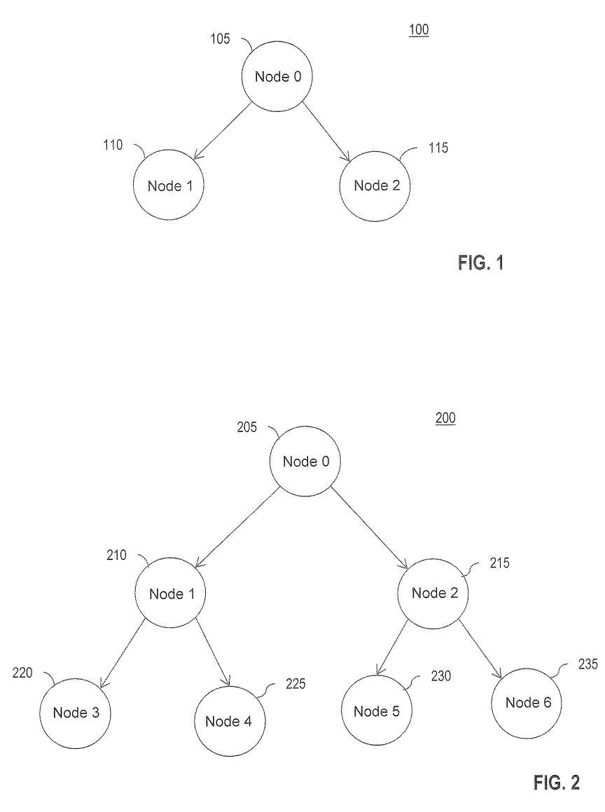

Extending the depth of the tree another level, both node 1 and node 2 have 2 children each. This embodiment is depicted in FIG. 2. FIG. 2 is a block diagram illustrating two hops of a multi-path network 200 in accordance with an example embodiment. As with network 100 discussed above, the network 200 may be part of a larger multi-hop, multi-path network. In network 100, all data traffic that is communicated in the network 200 may enter the network 200 via a single node (called root node), in this case, the Node 0 205.

In the network 200, if the same approach is used to determine hash keys and the same hash function is used for all nodes, an issue arises at the second layer of the network 200 as flows are received at Node 1 210 and Node 2 215. In this situation, each packet arriving at Node 1 210 will yield the same hash key as Node 0 205, when operating on the same subset of packet fields (which is a common approach). Given the same hash function (e.g., a CRC16 hash function) and number of children, the result of the hashing process at Node 0 205 will be replicated at Node 1 210. Consequently, all flows that arrive at Node 1 210 will be sent to Node 3 220 as these are the same flows that went “left” at Node 0 205. Because, in this arrangement, the same mathematical transformation (hash function) is performed on the same inputs (hash keys) at each node in the network, the next-hop/link selected by the hash algorithm remains unchanged at each hop. Thus, the next-hop/link selection between two or more nodes in the flow path (e.g., Node 0 205 and Node 1 210) is highly correlated, which may lead to significant imbalance among nodes.

For a binary tree with a depth of 2 hops (three layers), the consequence of this approach is that all flows that went “left” at the Node 0 205 and arrived at the Node 1 210 (e.g., all flows arriving at the Node 1 210 from Node 0 205), will again go “left” at Node 1 210 and arrive at Node 3 220. As a result, Node 4 225 will not receive any data traffic, thus leaving it starved. Similarly, all traffic sent to the Node 2 215 will be propagated “right” to the Node 6 235, thereby starving the Node 5 230. As the depth of such a network increases, this problem is exacerbated given that the number of leaf nodes increases (e.g., exponentially), but only two nodes at each level will receive data traffic.

As described above, some fields in a received packet may be limited in the amount of unique information they contain. This impacts the distribution of the hash and leads to imbalance in certain scenarios. As a result, the outputs of a hash function using these fields as input are inadequate for many applications such as traffic distribution. The techniques described herein remap one or more of these fields to new values before presenting the hash key to the hash function. These techniques improve hash function performance and improve the uniqueness of hash outputs. As discussed in further detail below, the following techniques, when applied in aggregate member selection, reduce the correlation associated with path selection in a multi-hop network, while also providing some degree of determinism by utilizing configured per-device attributes.

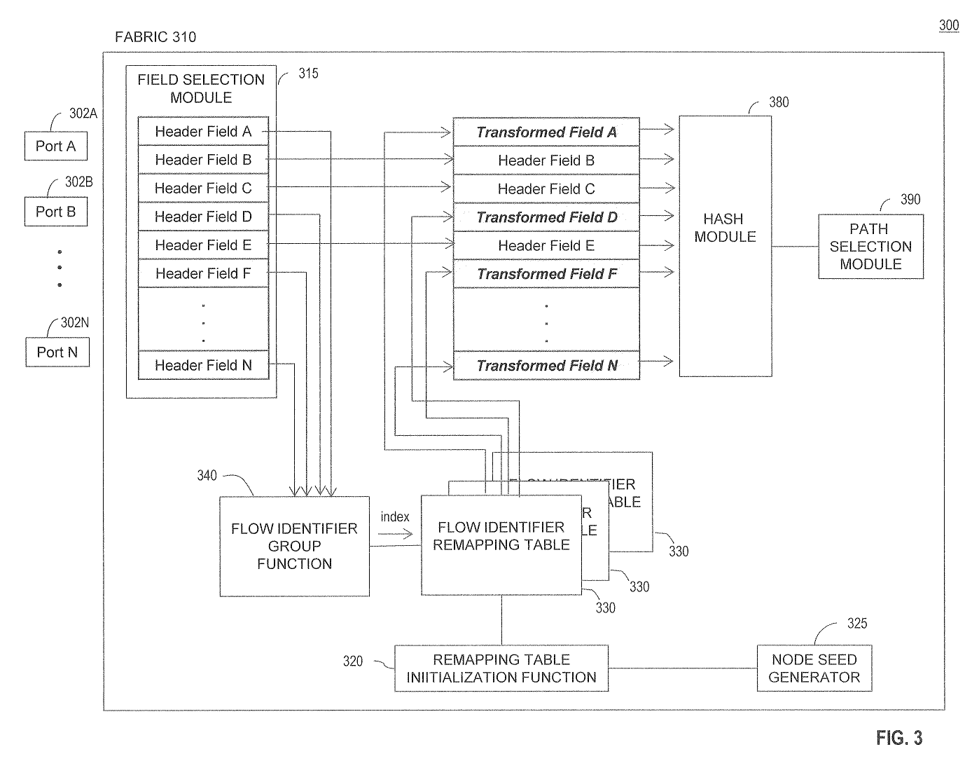

FIG. 3 is a block diagram illustrating a network node 300, in accordance with an embodiment of the present invention. Network node 300 may be a network switch, a router, a network interface card, or other appropriate data communication device. Node 300 may be configured to perform the load balancing techniques described herein.

Node 300 includes a plurality of ports 302A-N (Ports A through N) configured to receive and transmit data packets over a communications link. Node 300 also includes switching fabric 310. Switching fabric 310 is a combination of hardware and software that, for example, switches (routes) incoming data to the next node in the network. In an embodiment, fabric 310 includes one or more processors and memory.

Fabric 310 includes a field selection module 315. Field selection module 315 is configured to receive a packet and to extract one or more fields from the incoming packet to use as the hash key (referred to as the hash key fields). Field selection module 315 is further configured to select one or more of the hash key fields for remapping.

Fabric 310 also includes one or more flow identifier remapping tables 330. Flow identifier remapping table 330 is configured to perform a transformation of flow attributes (e.g., one or more packet fields) to unique per node values. A flow identifier remapping table 330 includes a plurality of entries associated with a field to be remapped. In an embodiment, fabric 310 includes one flow identifier remapping table for each field to be remapped. In an alternative embodiment, the flow identifier remapping table 330 includes a column for each field to be remapped.

Field selection module 315 is coupled to the one or more flow identifier remapping tables 330. In an embodiment, the index into the flow identifier remapping table is the value of the field to be remapped. In an alternate embodiment, an index function generates the index into the flow identifier remapping table 330 using one or more of the packet fields.

Flow identifier remapping table 330 is configured to output a transformed value for each field to be remapped. As illustrated in FIG. 3, the transformed values are substituted for the original values in the hash key. The transformed hash key is then provided as input to hash function 380. Further details on the remapping operation are provided below.

Fabric 310 may further include a flow identifier group function 340. Flow identifier group function 340 is optional. When present, flow identifier group function 340 maps multiple flow identifiers into an identifier group. The input of flow identifier group function 340 is a plurality of packet fields. The output of the flow identifier group function 340 is an index into the flow identifier mapping table. In embodiments, fabric 310 may include a plurality of flow identifier group functions 310.

Fabric 310 further includes a remapping table initialization function 320. Remapping table initialization function 320 is configured to initialize the one or more flow identifier remapping tables with a unique value per table entry. The initialization function is consistent across all nodes in a network. The unique set of values is generated according to per node attributes, such as a per node seed value. In an embodiment, the per node seed value is generated in a seed generator 325. In alternate embodiments, the per node seed is provided by a user. Alternatively, per-node uniqueness is achieved by varying the order in which the values appear in the table at each node.

Hash module 380 generates a hash value using the transformed hash key as input. In an embodiment, hash module 380 includes a hash function. The hash function is an arbitrary function that can transform the selected packet fields which include the remapped value or values (transformed hash key) into a single, smaller hash value. In embodiments, the hash function 380 may be a CRC (e.g., CRC16 or CRC32), a mapping table, or similar function.

Hash module 380 is coupled to path selection module 390. Path selection module 390 is configured to identify a next/hop (link) for the packet using the hash value. In an embodiment, the path selection module 380 includes a modulo function.

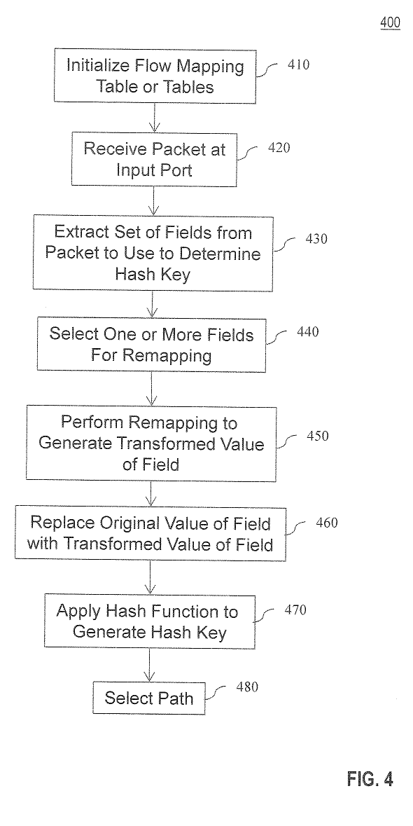

FIG. 4 is a flowchart illustrating a method 400 for hash-based load balancing with flow identifier remapping, according to an embodiment of the present invention. The method 400 may be implemented in the network 100 or the network 200 where any or all of the network nodes may individually implement the method 400. Method 400 is described with reference to the illustrations depicted in FIGS. 3, 5, and 7-9. However, method 400 is not limited to those embodiments.

In step 410, the flow mapping table or tables are initialized. In an embodiment, each entry in the flow remapping table is initialized with a value. A flow mapping table performs a transformation of flow attributes (e.g., packet fields) to per node values. The initialization of the flow mapping table entries is described in further detail below.

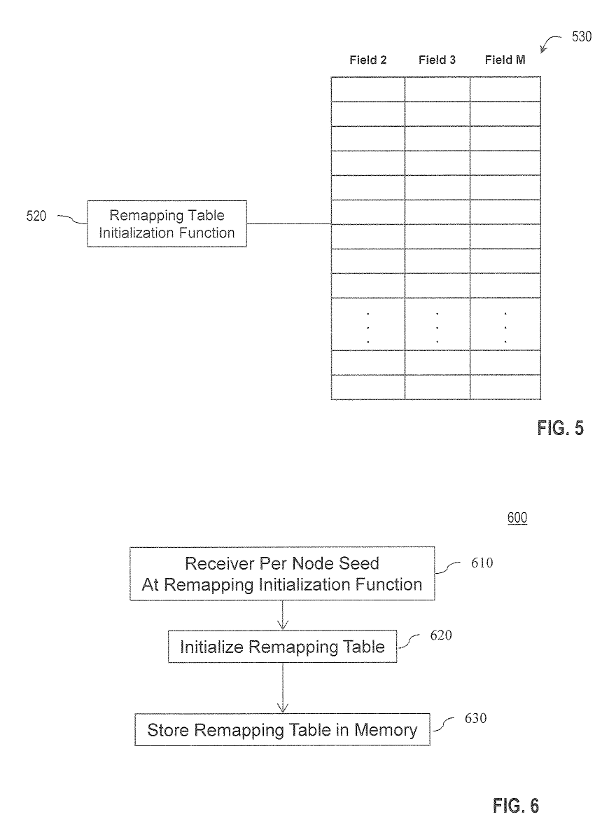

FIG. 5 depicts high level block diagram of a system 500 for initialization of the flow identifier remapping table, according to embodiments of the invention. As illustrated in FIG. 5, system 500 includes a remapping table initialization function 520 and a flow identifier remapping table 530.

Flow identifier remapping table 530 includes one or more columns. Each column may represent a different packet field. Each column includes a plurality of entries (rows). In embodiments, the size of the flow identifier remapping table 530 is determined by a user. In embodiments, the number of entries (rows) may be based on the width of certain packet fields. For example, if the selected packet field is 8-bits, then the corresponding flow identifier remapping table column has 256 entries.

Remapping table initialization function 520 initializes flow identifier remapping table with a unique value per entry, where the unique set of values is generated according to per node attributes such as a per node seed value 522. The remapping table initialization function 520 is typically the same at every node to ensure a user can determine the path selected at each hop for a given flow. To minimize correlation and provide good flow distribution, the function is provided unique inputs at each node (e.g., per node seed). In an embodiment, the per node seed is defined by a user. Alternatively, the per node seed may be generated at the node in a seed generator.

FIG. 6 is a flowchart illustrating a method 600 for initialization of the flow mapping table, according to an embodiment of the present invention. Method 600 is described with reference to the illustration depicted in FIG. 5. However, the method 600 is not limited to that embodiment.

In step 610, a per node seed 610 is provided to the remapping table initialization function 520 of the node.

In step 620, the remapping table is initialized using the remapping table initialization function. In this step, the remapping table initialization function provides a value for each entry associated with a packet field.

In step 630, the remapping table is stored in memory in the node.

As discussed above, in embodiments, a node may have multiple remapping tables. In these embodiments, method 600 would be performed to initialize each remapping table.

Returning to FIG. 4, in step 420, a data packet is received by the node. The data packet has a plurality of fields.

In step 430, a set of fields is extracted from the received packet for use in generating a hash key. In an embodiment, the set of fields extracted include attributes unique to a given flow, such as the entropy field.

In step 440, one or more of the hash key fields are selected for remapping.

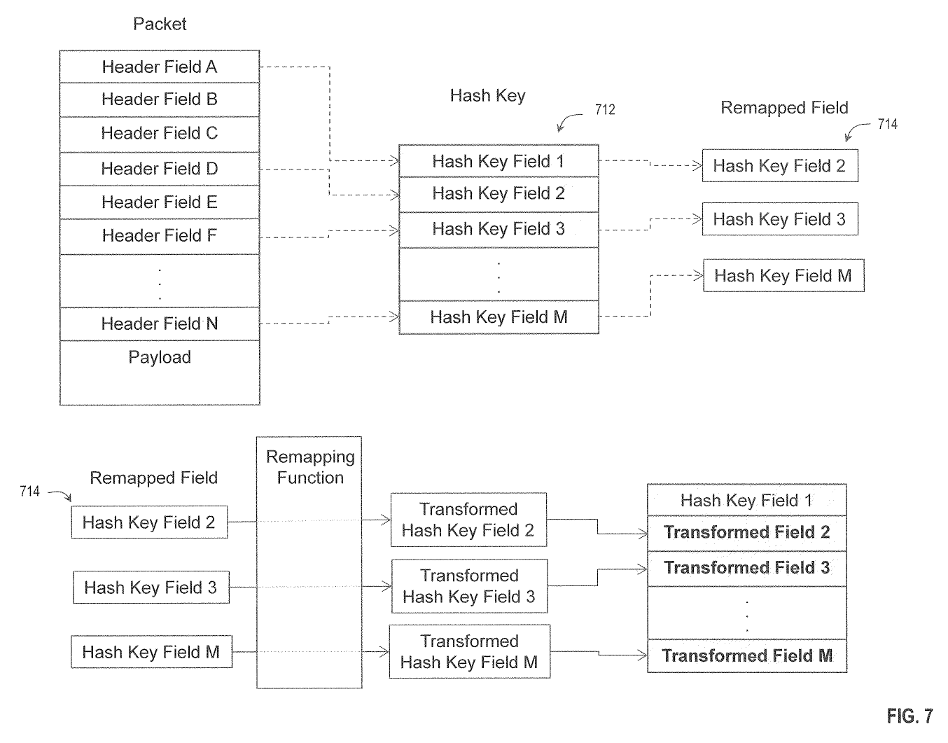

FIG. 7 illustrates the extraction and selection of packet fields for remapping, according to embodiments of the present invention. As illustrated in FIG. 7, a set of fields from the received packet 710 is extracted. For ease of discussion, these are referred to as the hash key fields. From the set of extracted hash key fields, one or more fields are selected for remapping. For ease of discussion, these fields are referred to as remapped field. As illustrated in FIG. 7, three of the extracted hash key fields have been selected as remapped fields.

In step 450, each of the one or more remapped fields is remapped to generate a transformed field. In an embodiment, a one-to-one remapping is performed.

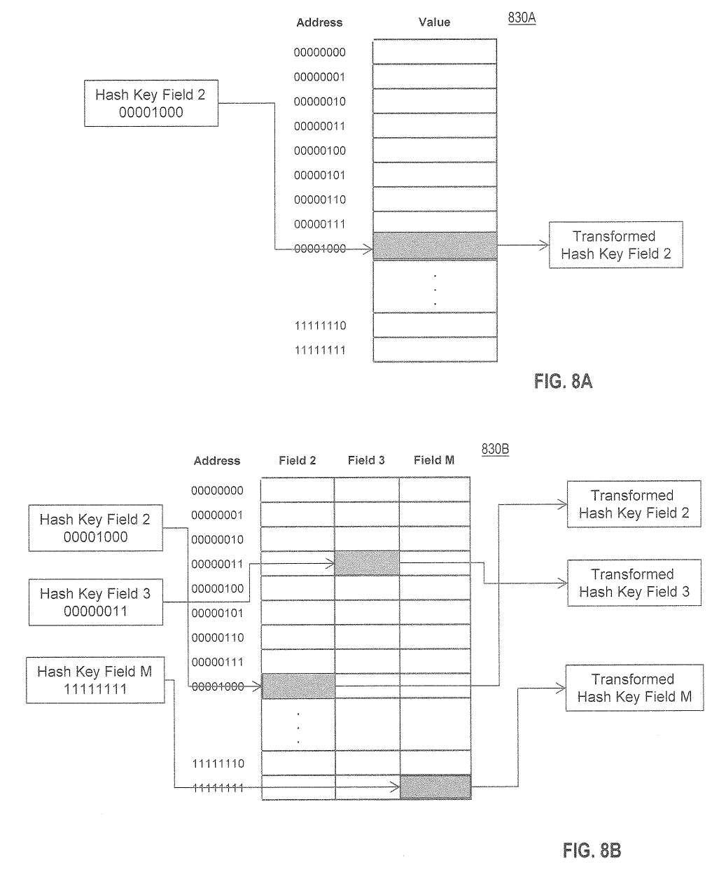

FIG. 8A illustrates an exemplary one-to-one remapping for a single field, according to embodiments of the present invention. In a one-to-one mapping, the value of the remapped field is used as the index into the flow identifier remapping table. The Flow Identifier Remapping Table 830A includes 256 entries (labeled 0 to 255) associated with packet field 2. In this example, hash key field 2 has a value of 127. In step 450, the system obtains the value stored in entry 127 of the remapping table and assigns this value as the transformed value for hash key field 2.

FIG. 8B illustrates an exemplary one-to-one remapping for multiple fields, according to embodiments of the present invention. The Flow Identifier Remapping Table 830B includes 3 columns, one column associated with each remapped field. Column A (hash key field 2) includes 256 entries (labeled 0 to 255); column B (hash key field 3) includes 256 entries (labeled 0 to 255); and column C (hash key field M) also includes 256 entries (labeled 0 to 255). In this example, hash key field 2 has a value of 127; hash key field 3 has a value of 3; and hash key field M has a value of 255. In step 450, the system obtains the value stored in entry 127 of Column A and assigns this value as the transformed value for hash key field 2. The system also obtains the value stored in entry 3 of Column B and assigns this value as the transformed value for hash key field 3. The system further obtains the value stored in entry M of Column C and assigns this value as the transformed value for hash key field M.

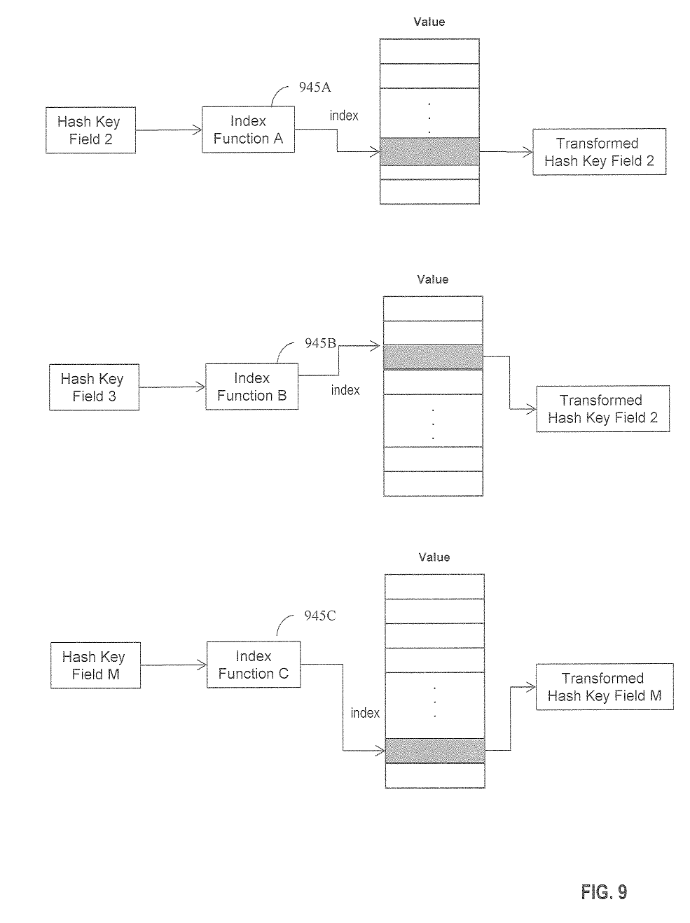

In an alternate embodiment, the remapped fields are provided to an index function. The index function generates an index from one or more input values. FIG. 9 illustrates an example of the use of a remapping function, according to embodiments of the present invention. As illustrated in FIG. 9, the system may include one or more index functions. The index function may be a hash function, mapping table, or similar function. In an embodiment, each remapped field is provided to a separate index function. For example, in FIG. 9, hash key field 2 (remapped field) is provided to index function 945A; hash key field 3 (remapped field) is provided to index function 945B; and hash key field M (remapped field) is provided index function 945C. In an alternate embodiment (not shown), an index function may generate an index for multiple remapped fields.

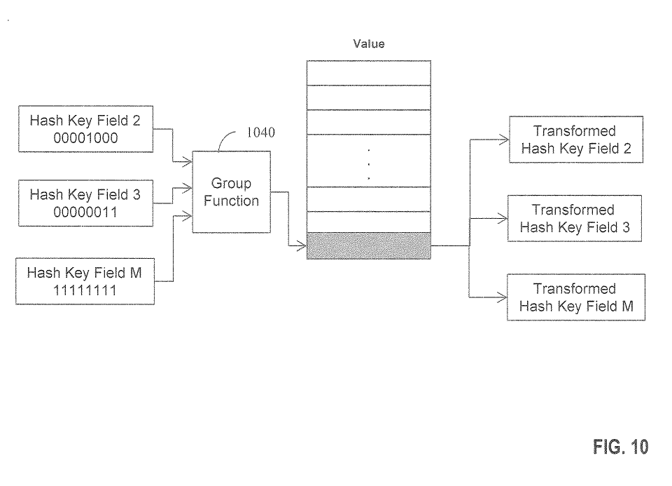

In a further alternate embodiment, a remapping of a group of fields is performed. FIG. 10 illustrates an exemplary group remapping, according to embodiments of the present invention. The embodiment of FIG. 10 includes a flow identifier group function 1040. This is an optional element. When present, the flow identifier group function 1040 maps a plurality of flow identifiers into an identifier group. Grouping of flow identifiers enables the size of the Flow Identifier Remapping Table to be reduced at the expense of some potential performance impact in terms of flow distribution. As illustrated in FIG. 10, a group of flow identifiers are provided to the flow identifier group function 1040. The flow identifier group function 1040 maps the flow identifiers into an identifier group. The function associates an index with the identifier group. The system obtains the value stored in the associated entry of the remapping table and assigns this value as the transformed value for the hash key fields in the group.

Returning to FIG. 4, in step 460, the selected hash key fields are replaced with the transformed values. FIG. 7 illustrates the process of replacing the transformed value into the hash key fields.

In step 470, the set of hash key fields, included the transformed fields, are presented to a hash function 380 as the hash key. In an embodiment, the hash function is an arbitrary function that can transform the selected packet fields (referred to as the hash key fields) which include the transformed value or values into a single, smaller hash value.

In step 480, the hash value is provided to path selection module 390 which identifies the next hop/link (path) for the packet.

The node-based remapping of flow identifiers introduces more information (entropy) to the path selection process. This is achieved by injecting new values into the hash key on a per node basis. A key aspect to maintaining deterministic behavior is to have a single Remapping Table Initialization Function that is consistent across all nodes, to make updates to the Flow Identifier Remapping Table using a set of values that are unique to the node where uniqueness is denoted by either the value or the order in which values appear in the table. This action minimizes correlation in the multi-hop framework by introducing per-node attributes into the path selection process.

All or a portion of the methods described above may be performed by one or more processors executing a computer program product. Additionally, or alternatively, one or all components of the above methods may be performed by special purpose logic circuitry such as a field programmable gate array (FPGA) or an application specific integrated circuit (ASIC).

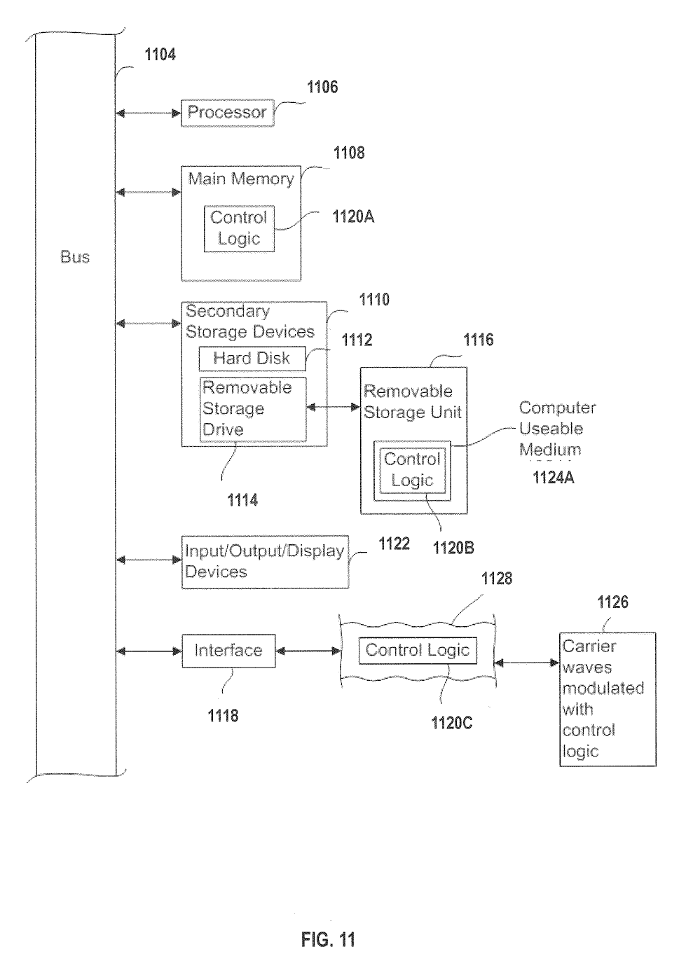

FIG. 11 illustrates an example computer system 1100 in which embodiments of the present invention, or portions thereof, can be implemented as computer-readable code. For example, the method illustrated by flowchart 400 can be implemented in system 1100. However, after reading this description, it will become apparent to a person skilled in the relevant art how to implement embodiments using other computer systems and/or computer architectures.

Computer system 1100 includes one or more processors, such as processor 1106. Processor 1106 can be a special purpose or a general purpose processor. Processor 1106 is connected to a communication infrastructure 1104 (for example, a bus or network).

Computer system 1100 also includes a main memory 1108 (e.g., random access memory (RAM)) and secondary storage devices 1110. Secondary storage 1110 may include, for example, a hard disk drive 1112, a removable storage drive 1114, and/or a memory stick. Removable storage drive 1114 may comprise a floppy disk drive, a magnetic tape drive, an optical disk drive, a flash memory, or the like. Removable storage drive 1114 reads from and/or writes to a removable storage unit 1116 in a well-known manner. Removable storage unit 1116 may comprise a floppy disk, magnetic tape, optical disk, etc. which is read by and written to by removable storage drive 1114. As will be appreciated by persons skilled in the relevant art(s), removable storage unit 516 includes a computer usable storage medium 1124A having stored therein computer software and/or logic 1120B.

Computer system 1100 may also include a communications interface 1118. Communications interface 1118 allows software and data to be transferred between computer system 1100 and external devices. Communications interface 1118 may include a modem, a network interface (such as an Ethernet card), a communications port, a PCMCIA slot and card, or the like. Software and data transferred via communications interface 1118 are in the form of signals which may be electronic, electromagnetic, optical, or other signals capable of being received by communications interface 1118. These signals are provided to communications interface 1118 via a communications path 1128. Communications path 1128 carries signals and may be implemented using wire or cable, fiber optics, a phone line, a cellular phone link, an RF link or other communications channels.

In this document, the terms “computer usable medium” and “computer readable medium” are used to generally refer to media such as removable storage unit 1116 and a hard disk installed in hard disk drive 1112. Computer usable medium can also refer to memories, such as main memory 1108 and secondary storage devices 1110, which can be memory semiconductors (e.g. DRAMs, etc.).

Computer programs (also called computer control logic) are stored in main memory 1108 and/or secondary storage devices 1110. Computer programs may also be received via communications interface 1118. Such computer programs, when executed, enable computer system 1100 to implement embodiments of the present invention as discussed herein. In particular, the computer programs, when executed, enable processor 1106 to implement the processes of the present invention. Where embodiments are implemented using software, the software may be stored in a computer program product and loaded into computer system 1000 using removable storage drive 1114, interface 1118, or hard drive 1112.

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of embodiments of the present invention should not be limited by any of the above-described exemplary embodiments, but should be defined only in accordance with the following claims and their equivalents.

What is claimed is:

1. A method for improving hash function performance in a network device, comprising:
receiving, at the network device, a data packet having a plurality of fields;
selecting a first set of fields from the data packet as a hash key;
selecting a first field from the first set of fields, the first field having a value;
transforming the value of the first field to a transformed value;
replacing, in the hash key, the value of the first field with the transformed value to create a transformed hash key; and
generating a hash value, in a hash module, using the transformed hash key as input.

2. The method of claim 1, wherein transforming the value of the first field to a transformed value includes:
generating an index into a flow identifier remapping table; and
retrieving a value stored in the flow identifier remapping table using the index, wherein the retrieved value is the transformed value of the first field.

3. The method of claim 2, wherein generating the index into the flow identifier remapping table includes:
assigning the value of the first field as the index into the flow identifier remapping table.

4. The method of claim 2, wherein generating the index into the flow identifier remapping table includes:
receiving the first field in an index generation function; and
generating the index by applying an arbitrary function to the first field.

5. The method of claim 4, wherein the arbitrary function is a hash function.

6. The method of claim 1, further comprising:
selecting a path in a plurality of paths using the hash value.

7. The method of claim 6, wherein selecting the path includes:
applying a modulo function to the hash value.

8. The method of claim 2, further comprising:
prior to receiving the data packet,
initializing the flow identifier remapping table using a seed value.

9. The method of claim 8, wherein the seed value is unique for the network device.

10. The method of claim 8, wherein the seed value is generated in the network device.

11. A computer program product comprising a non-transitory computer useable medium having computer program logic recorded thereon, the computer control logic when executed by a processor enabling the processor to process packet data according to a method, the method comprising:
selecting a first set of fields from a received data packet as a hash key;
selecting a first field from the first set of fields, the first field having a value;
transforming the value of the first field to a transformed value;
replacing, in the hash key, the value of the first field with the transformed value to create a transformed hash key; and
generating a hash value, in a hash module, using the transformed hash key as input.

12. The computer program product of claim 11, wherein transforming the value of the first field to a transformed value includes:
generating an index into a flow identifier remapping table; and
retrieving a value stored in the flow identifier remapping table using the index, wherein the retrieve value is the transformed value of the first field.

13. The computer program product of claim 12, wherein generating the index into the flow identifier remapping table includes:
assigning the value of the first field as the index into the flow identifier remapping table.

14. The computer program product of claim 12, wherein generating the index into the flow identifier remapping table includes:
receiving the first field in an index generation function; and
generating the index by applying an arbitrary function to the first field.

15. The computer program product of claim 14, wherein the arbitrary function is a hash function.

16. The computer program product of claim 11, further comprising:
selecting a path in a plurality of paths using the hash value.

17. The computer program product of claim 16, wherein selecting the path includes:
applying a modulo function to the hash value.

18. The computer program product of claim 12, further comprising:
prior to receiving the data packet,
initializing the flow identifier remapping table using a seed value.

19. The computer program product of claim 18, wherein the seed value is unique for the network device.

20. The computer program product of claim 18, further comprising:
generating the seed value.
